(19) United States
(12) Patent Application Publication
(10) Pub. No.: US 2025/0258032 A1
(43) Pub. Date: Aug. 14, 2025

(54) RADAR-BASED LIQUID VOLUME DETECTION IN A MOVING VESSEL AND USE OF RADAR SENSOR ON AGRICULTURAL IMPLEMENT

(71) Applicant: Kinze Manufacturing, Inc., Williamsburg, IA (US)

(72) Inventors: Jeremy Nadke, Williamsburg, IA (US); Jason Schoon, Williamsburg, IA (US); Bryton Hayes, Williamsburg, IA (US); Steve Nolte, Williamsburg, IA (US); Corby Withrich, Williamsburg, IA (US); Philip Willis, Williamsburg, IA (US)

(21) Appl. No.: 19/051,777

(22) Filed: Feb. 12, 2025

Related U.S. Application Data
(60) Provisional application No. 63/552,473, filed on Feb. 12, 2024.

(51) Int. Cl. G01F 23/284; G01C 21/18; G01S 13/10

(52) U.S. Cl. CPC G01F 23/284; G01C 21/18; G01S 13/10

(57) ABSTRACT

Agricultural inputs, such as liquid fertilizer, is stored in a tank. The tank can be positioned on an agricultural implement. The level of liquid in the tank will vary upon application, and determining the level remaining in the tank presents a problem, especially when the implement is tilted or angled, such as on a side hill. A phase coherent pulse radar sensor in conjunction with a six degree-of-free sensor can provide the needed information for determining the volume in the tank as the implement moves in a field and over unlevel terrain. The radar and sensor can also be used to determine positional aspects of the implement, such as heading, speed, orientation, pitch, yaw, and the like.

### CROSS REFERENCE TO RELATED APPLICATIONS

This application claims priority under 35 U.S.C. § 119 (e) to provisional patent application U.S. Ser. No. 63/552,473, filed Feb. 12, 2024. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to sensors and sensor systems used in agriculture, such as with agricultural implements. More particularly, but not exclusively, the disclosure includes apparatus, systems, and methods of using sensors and sensor systems with agricultural implements for better monitoring of liquid levels and/or particulate levels in a tank or bin, as well as with location, orientation, and/or movement of an agricultural implement.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Agricultural fertilizer systems generally include the application of dry or liquid fertilizers. For those that do not use a liquid, they use granular or other forms of fertilizer that are difficult to handle and apply, difficult to blend and to apply uniformly. Because of this, other prior art has transitioned to liquid fertilizers. Consistent application of liquid fertilizer can prove problematic depending on the density of the fertilizer being used. Differing densities of liquid fertilizer can cause differing results in terms of application, which leads to inconsistencies in application. The densities can vary based upon a number of factors, including, but not limited to, ambient environment, combination of inputs, accuracy of desired combination, as well as others. The same fertilizer distribution system may perform poorly when a different fertilizer having a different density is used, as differing densities may cause problems when measuring the fullness of a tank/hopper containing liquid fertilizer material. Also, even in situations when the same fertilizer is used, weather conditions, such as ambient air pressure, can cause fluctuations in the density of the liquid fertilizer.

Inconsistent or undesirable application of liquid fertilizer can be problematic from both an agricultural/financial perspective and/or a safety/environmental perspective. For example, if less liquid fertilizer than is desirable is applied to an agricultural field, the crops in the field may suffer due to lack of nutrients based on lack of exposure to the proper amount of fertilizer. Thereby, a farmer's potential yield could suffer, which has a negative impact on the farmer's financial outlook. Also, spillage of fertilizer material results in financial loss for a farmer as the farmer is then forced to spend more money on additional fertilizer material to replace the spilled fertilizer material. Over-application results in a farmer spending more money since more fertilizer material than is necessary is applied to an agricultural field. Additionally, from a safety/environmental perspective, applying more liquid fertilizer than is desirable can result in increased amounts of chemical runoff from the agricultural field. Humans and other animals in the surrounding area could potentially be negatively affected by being exposed to caustic or hazardous chemical runoff, and the surrounding environment could also be negatively affected due to increased chemical runoff.

Consistent application of liquid fertilizer can also prove problematic in situations wherein an agricultural field may contain hills or slightly sloped or rough terrain. Sloped areas in an agricultural field can cause agricultural equipment and/or fertilizer distribution equipment to tilt or otherwise be oriented in a non-horizontal manner with respect to the horizon. The tilted orientation may cause problems in the distribution of the liquid fertilizer, such as when there are multiple tanks, and one tank may be on the low end. When fertilizer distribution equipment encounters sloped or rough areas in an agricultural field, the tilting of the equipment may cause a tank containing liquid fertilizer to spill. When spillage occurs in an agricultural field, over-application may occur and/or human operators may be exposed to the fertilizer material which is often caustic or hazardous to humans. Spillage is also harmful to the environment at large, as it may result in unwanted chemical runoff. In addition, spillage is wasteful from a financial standpoint as it may result in a farmer needing to spend more money on additional fertilizer material to replace the spilled material.

However, measuring the amount of liquid fertilizer (or dry material) can be difficult, especially with everchanging amounts in the tanks. Weight-based sensors are expensive and non-volumetric as they require a conversion knowing the liquid density. Ultrasonic sensors require contact with corrosive liquids and have non-uniform accuracy across their usable range. LiDAR sensors also have limitations, as they are not able to correctly adjust and determine levels of liquids across the surface areas. In addition, LiDAR cannot see through the tank/vessel directly and is unreliable under the present of optical scattering (which can be caused by liquids). Thus, none of the sensors detect motion of the liquid for accurate volumetric calculation.

Therefore, there is a need in the art for a sensor and/or sensor system that better determines volumetric amounts of liquid and/or dry materials in a bin, such as determining the level of the material in the bin.

In addition, sensors have been used on agricultural implements to aid in providing additional information. Such information includes, but is not limited to, heading, speed, orientation, and other positional information. This can include nine-degrees of freedom to provide such information.

However, multiple units are required on a planter that can add to the cost and/or complexity of the system. Having one or more of the units that do not work properly creates issues for the operation of the agricultural implement, which can affect the ability to accurately plant within the desired timeframe.

Thus, there exists a need in the art for a sensor system that can be used on an agricultural implement that provides positional information utilizing fewer components and/or less complexity.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of any of the aspects and/or embodiments of the present disclosure to improve on or overcome the deficiencies in the art.

It is a further object, feature, and/or advantage of any of the aspects and/or embodiments of the present disclosure to provide improved and accurate measurements for the level of a liquid in a tank of an agricultural implement. For example, a radar sensor system could be used with liquid fertilizer tanks to measure and monitor the amount and levelness of product within the tank or tanks.

It is still yet a further object, feature, and/or advantage of any of the aspects and/or embodiments of the present disclosure to measure and monitor the amount of liquid material in a tank while the tank is moving and/or tilting.

It is yet another object, feature, and/or advantage of any of the aspects and/or embodiments of the present disclosure to use the radar sensor system to aid in providing positional information for an agricultural implement.

The aspects and/or embodiments disclosed herein can be used in a wide variety of applications. For example, while measuring and monitoring liquid material is disclosed, it should be appreciated that any material that moves during operation or changes quantity could be monitored using the same or similar system. In addition, as noted, the sensor system disclosed herein could be used for monitoring volume, levelness, changes, or other variations of a material, as well as changes to position of the implement as a whole.

It is preferred the apparatus be safe, cost effective, and durable. For example, as will be understood, the sensor and system disclosed herein is utilized with agricultural implements, and thus, may undergo various stresses and forces due to changing terrain and environmental conditions.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the apparatus or system as disclosed.

Methods can be practiced which facilitate use, manufacture, assembly, maintenance, and repair of an apparatus or system which accomplish some or all of the previously stated objectives.

The apparatus or system can be incorporated into systems or kits which accomplish some or all of the previously stated objectives.

According to some aspects of the present disclosure, a system for measuring and monitoring liquid volume in a moving vessel comprises a user interface; and a sensor system operatively connected to the moving vessel and operatively connected to the user interface, the sensor system comprising a sensor housing; and a sensor circuit board positioned within the sensor housing and comprising a radar sensor comprising a radar sensor and an inertial movement sensor both connected to a control unit; wherein the sensor system communicates volume of a liquid in the moving vessel to the user interface.

According to at least some aspects of some embodiments disclosed, the sensor housing comprises a cap and a base, wherein the sensor circuit board is positioned between the cap and base.

According to at least some aspects of some embodiments disclosed, the system further comprises electrical wiring through a portion of the sensor housing to connect to the sensor circuit board.

According to at least some aspects of some embodiments disclosed, the electrical wiring connects the sensor system to the user interface.

According to at least some aspects of some embodiments disclosed, the electrical wiring comprises Ethernet.

According to at least some aspects of some embodiments disclosed, the sensor system is connected to the user interface wirelessly.

According to at least some aspects of some embodiments disclosed, the inertial movement sensor comprises a six degree-of-freedom sensor.

According to at least some aspects of some embodiments disclosed, the six degree-of-freedom sensor comprises a 3D accelerometer and a 3D gyroscope.

According to at least some aspects of some embodiments disclosed, the radar sensor comprises a 60 GHz radar sensor.

According to at least some aspects of some embodiments disclosed, the sensor circuit board comprises one or more pin connectors.

According to additional aspects of the disclosure, a sensor system for use with an agricultural implement comprises a sensor housing; an electronic sensor positioned within the sensor housing, the electronic sensor comprising a control unit; a radar sensor coupled to the control unit; and an inertial movement sensor coupled to the control unit; wherein the inertial movement sensor comprises six degrees-of-freedom sensing.

According to at least some aspects of some embodiments disclosed, the radar sensor comprises a 60 GHz radar sensor.

According to at least some aspects of some embodiments disclosed, the sensor housing comprises a cap and a base, wherein the sensor circuit board is positioned between the cap and base.

According to at least some aspects of some embodiments disclosed, the inertial movement sensor comprises a 3D accelerometer and a 3D gyroscope.

According to at least some aspects of some embodiments disclosed, the agricultural implement comprises a planting implement.

According to at least some aspects of some embodiments disclosed, the sensor system further comprises a user interface in communication with the electronic sensor and configured to display information obtained by the sensor.

According to additional aspects of the disclosure, a method of sensing a liquid volume of a liquid in a moving vessel comprises sensing, via a radar sensor, reflected signals from the liquid to determine a distance to the liquid in the vessel; determining, via the radar sensor, a phase coherence of an inside of the vessel; measuring velocity information of the liquid moving in the vessel; determining, via an inertial movement sensor, an angle of the moving vessel to provide an offset to a known level of the vessel; detecting, via the inertial movement sensor, an external movement force being applied to the vessel to determine when the liquid should be moving; and determining, based on the detection, a trust value between the distance of the liquid determined in the vessel and velocity information of the liquid.

According to at least some aspects of some embodiments disclosed, the step of sensing comprising use of a phase coherent pulse radar that emits electromagnetic signals over time in which correlated phase is maintained between the electromagnetic signals.

According to at least some aspects of some embodiments disclosed, the method further comprises comparing the measured velocity information with other material in the vessel that generates a signal reflection.

According to at least some aspects of some embodiments disclosed, the method further comprises using the velocity information to discriminate between a liquid that is not part of the volume to be measured and the moving liquid in the vessel.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a perspective view of an agricultural planting implement.

FIG. 2 is a side elevation view of the agricultural planting implement.

FIG. 3 is a schematic of a fertilizer system with multiple vessels wherein a liquid is stored in the vessels and the vessels move with an implement.

FIG. 4 is depiction of a display of a user interface showing determinations of liquid fertilizer tank levels and other fertilizer information.

FIG. 5 is a perspective view of a sensor system according to at least some aspects of some embodiments of the present disclosure.

FIG. 6 is an exploded view of FIG. 5.

FIG. 7 is a perspective view of an upper portion of the sensor system.

FIG. 8 is an exploded view of FIG. 7.

FIG. 9 is a perspective view of a printed circuit board used with the sensor system according to at least some aspects of the disclosure.

FIG. 10 is a top plan view of the printed circuit board.

FIG. 11 is a front elevation view of the printed circuit board.

FIG. 12 is a bottom plan view of the printed circuit.

FIG. 13 is a schematic showing components of a sensor system according to at least some aspects of the present disclosure.

FIG. 14 is a schematic of a system including the sensor system.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

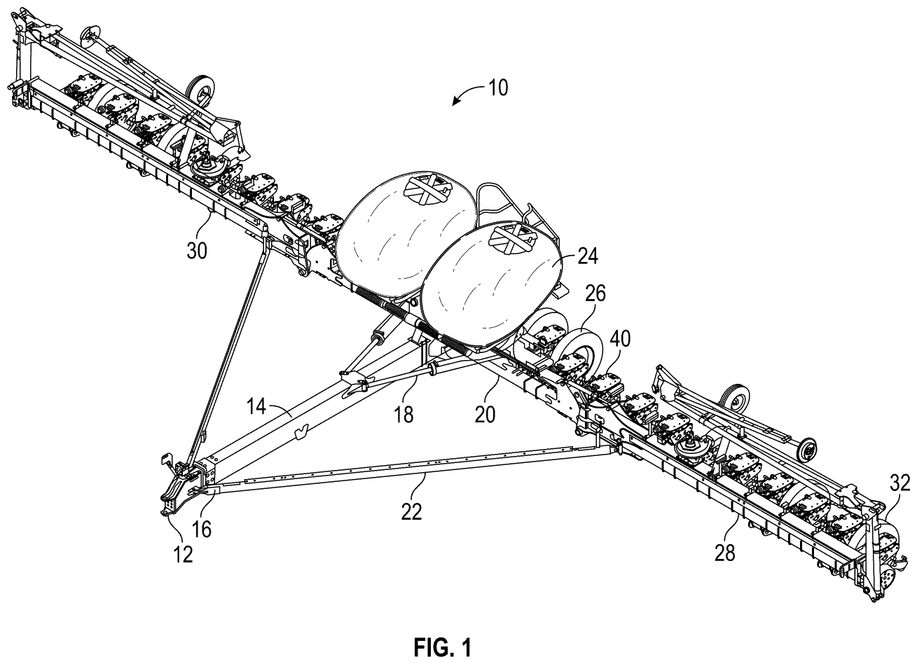

FIG. 1 shows an agricultural implement in the form of an agricultural planter 10 used to plant and fertilize seed in a controlled manner. The planter 10 as shown in FIG. 1 includes a tongue 14, which may be telescoping. The tongue 14 includes a first end 16 with an implement hitch 12 for attaching to a tow vehicle, such as a tractor, prime mover, or other vehicle. The opposite end 18 of the tongue 14 is attached to a toolbar 20. Draft links 22 are shown to be connected between the toolbar 20 and the tongue 14 and are used in conjunction with folding actuators to fold the toolbar 20 in a frontward manner. The tongue 14 maybe a telescoping tongue in that it can extend or retract to allow for the front folding of the toolbar 20. The planter 10 may also be a lift and rotate, rear fold, vertical fold, narrow row, or generally any other type of planter.

In addition, as noted, the implement may be a different type of ground engaging implement. For example, agricultural sprayers, plows, tillage equipment, seeders, drills, fertilizers, or other types of implements that can utilize the novel features disclosed herein should be considered a part of the disclosure.

The toolbar 20 includes first and second wings extending generally outwardly therefrom. The toolbar 20 includes central hoppers 24, which contain seed or other granules/particulate used with ground engaging tools, such as seed for planting. A plurality of transport wheels 26 also are connected to the toolbar 20. The first and second wings are generally mere images of one another in mirrored fashion. The wings include first and second wing toolbars, which are essentially extensions from a central toolbar portion. Attached along the toolbar 20 as well as the first and second wing are a plurality of row units 33. When the implement is a planting unit, the row units will include seed meters, ground engaging tools, and/or other components used for planting, tilling, and fertilizing seed in a controlled manner, such as many components that will be described in more detail herein. Also connected to the first and second wings are first and second markers. The markers include actuators, which are used to raise and lower the markers. The markers can be lowered to provide guidance for the edge of a planter for use in planting. When not required, the markers can be lifted to a position as that shown in FIG. 1 to move the markers out of the way.

Also shown in FIG. 1 are a plurality of fans as well as a plurality of wheels 32. The wings may also include actuators to raise and lower or otherwise provide a downward force on the wings. Therefore, as is shown in FIG. 1, there are a multiplicity of components of the planting implement 10. The components may include moving parts, such as the actuators used to move the wings, markers, row units, etc., while also providing additional functions. For example, the fans are used to provide a pressure in the seed meters to aid in adhering seed to a seed disk moving therein. The seed meters may be electrically driven in that a motor, such as a stepper motor, can be used to rotate the seed meters to aid in adhering seed thereto and to provide for dispensing of the seed in a controlled manner for ideal spacing, population, and/or placement. Other features may include actuators or other mechanisms for providing down force to the row units 33. Lights may also be included as part of the planter.

Additionally, an air seed delivery system may be provided between the central hoppers 24 and any plurality of seed meters on the row units 33 in that the air seed delivery system provides a continued flow of seed to the row units on an as needed manner to allow for the continuous planting of the seed via the seed meters on the row units. Thus, the various controls of the planter may require or otherwise be aided by the use of an implement control system. The implement control system can aid in controlling each of the functions of the implement or planter 10 so as to allow for the seamless or near seamless operation with the implement, and also provides for the communication and/or transmission of data, status, and other information between the components.

As will be appreciated, the planter need not include all of the features disclosed herein and may also include additional or alternative features as those shown and/or described. The foregoing has been included as an exemplary planter, and it should be appreciated that generally any planter from any manufacturer and any add-ons or aftermarket components may be included in any planter that encompasses any of the aspects of the invention.

A planter 10 such as that shown, can be pulled by the tow vehicle, such as the tractor. In addition, the planter 10 could be pulled by or itself be a self-propelled, autonomous tug unit, rather than an operator-driven vehicle, such as the tractor, such as the one shown and described in co-owned U.S. Pat. No. 10,575,453, which is herein incorporated by reference in its entirety. The rear drivable wheels and front steerable wheels can be substituted for tracks, regardless of whether said tracks are implemented on an operator-driven vehicle or a self-propelled vehicle.

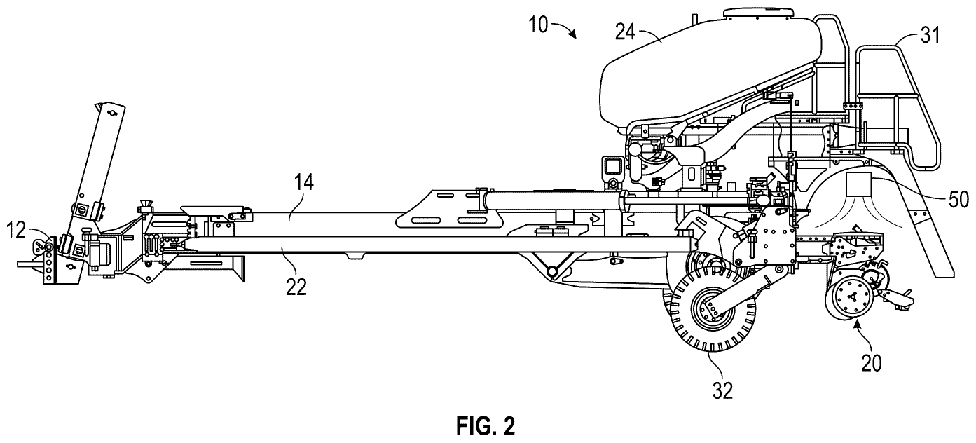

FIG. 2 is another view of an example implement 10 in the form of a planting implement. FIG. 2 is similar to FIG. 1 but does include some additional features not easily viewed in FIG. 1. For example, FIG. 2 better shows the location of a catwalk 31. An implement catwalk 31, such as the one shown in the figure, includes a ladder or stairs and a platform area for a user to access different areas of the implement. For example, the catwalk 31 shown in the figure can provide better access to the bulk hoppers 24 of the implement 10.

The catwalk 31 provides an access point where the stairs can extend to or beyond the row units 33. The user can walk up the stairs to the platform to view portions of the planter or to adjust, repair, diagnose, add product, or perform any other task associated with the location of the platform. It should be noted that the catwalk shown is for example purposes and should not be limiting to the disclosure.

As shown in FIG. 2, positioned generally underneath a portion of the catwalk 31 is a portion of a sensor system 50. As will be understood, the sensor system 50 can monitor and provide data to a user interface/display 41, which may be located in the tractor or remotely, such as on a computer or handheld device (e.g., phone, tablet, computer, smart device, etc.). The sensor shown in FIG. 2 is substantially downward and utilizes a combination of a radar sensor and an inertial measurement unit (IMU) with multiple degrees of freedom to provide information for the system. Such information can include, but is not limited to, speed, heading, pitch, elevation, yaw, roll, orientation, etc. It should be appreciated that the location of the sensor 50 should not be limiting on the disclosure, and it could be positioned generally anyone on the implement 10 to provide such information. Placing under the catwalk 31 provides some protection to the sensor 50.

To further aid in increasing the performance and growing of crop from a planted seed, implements can include systems and other apparatus that are used to apply, place, or otherwise dispense a fertilizer, such as a liquid or dry fertilizer material. For agricultural planting implements, a fertilizer applicator/distribution system, such as the system disclosed in U.S. patent application Ser. No. 17/937,059, filed Sep. 30, 2022, which is hereby incorporated in its entirety, can be included with the row units of the planter. This system provides the application of the fertilizer contemporaneously, or near-contemporaneously, with the planting of the seed. However, it should be appreciated that the system can be used to apply liquid fertilizer at other times, such as before or after the planting of the seed as well. The system can include one or more hoppers/tanks, either at the bulk hopper site, at the individual row units, or split out to cover regions or sections of row units, wherein the application sites will be fed an amount of the liquid fertilizer.

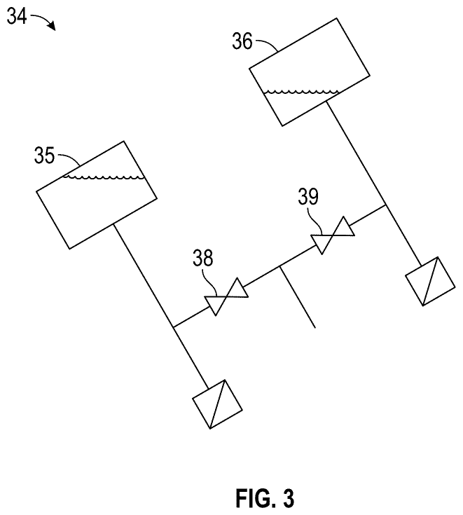

Still further, U.S. patent application Ser. No. 18/052,715, filed Nov. 4, 2022, and which is hereby incorporated by reference in its entirety, discloses additional aspects of a liquid fertilizer system, including the ability to adjust amounts of liquid in dual tanks. This is shown in FIG. 3 of the present disclosure, where a fertilizer tank system 34 includes a first tank 35 and a second tank 36, which may also be known as vessels. The fertilizer system 34 can be utilized with an implement, such as the implement 10 shown in the figures, and can be mounted thereon. The tanks each hold an amount of liquid fertilizer. As shown in the figure, the implement with the tanks appears to be at an angle, such as when traversing a sidehill. The level of liquid fertilizer in the tanks varies. It may be beneficial to draw the liquid fertilizer, such as via the first valve 38 and/or second valve 39 in order to mitigate spillage of the liquid.

However, to do so, it is beneficial to know the level of liquid in each of the tanks 35, 36. This can be difficult for liquid stored in vessels, especially as the liquid will move within the vessel during movement of the implement. The liquid will slush around and also be at various levels within the vessels based on speed of travel, elevation or pitch of terrain, and many other factors where the implement and vessels are not perfectly perpendicular to the ground.

Therefore, as will be understood, aspects of the disclosure include systems and methods for determining the amount or volume of a liquid in a moving vessel (moving due to being pulled or moving autonomously). The determination of the amount of liquid will provide advantages for the operator.

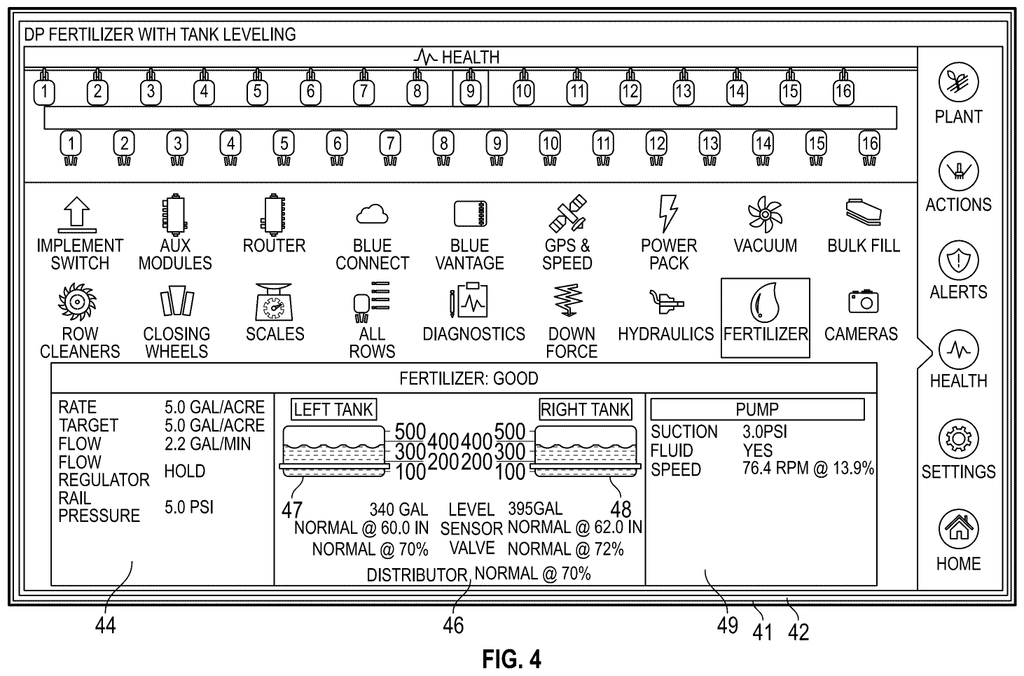

For example, FIG. 4 depicts an example of a screen that is part of a user interface or display 41. The user interface 41 can be a tablet or screen in the cab of a tractor or can be a remote device. For example, it is envisioned that the user interface could be a computer, server, handheld device (tablet or phone), or any smart device. The user interface 41 provides information related to the operation of the implement 10, and also is a machine-user interface to allow changes to be made via the interface.

FIG. 4 is an example of one screen that depicts information related to liquid fertilizer on the planter. The screen is part of a Health section of the user display 41. As shown in the bottom portion of the figure, the fertilizer information 42 is broken up into three sections. The first or left section 44 includes operating rates that are informative as to the operation of the liquid fertilizer system on the implement. The far right section 49 includes pump information for the liquid fertilizer system.

In the middle section 46, there is information and graphics related to the amount of liquid fertilizer. The figure shows a left tank 47 and a right tank 48, which may also be referred to as vessels storing the liquid fertilizer. The graphics related to the tanks indicate the level of liquid fertilizer therein. Beneath the graphics are values of information for the levels. The levels are important so that a user is able to determine when to refill or when there may be an issue with the operation of the fertilizer system.

When the implement 10 and/or vessels (e.g., tanks 47/48) are on level ground, it can be easy to determine the volume left in the tanks. However, when the implement is moving and/or on unlevel terrain, it can be difficult to ascertain an accurate volume. For example, as noted herein, weight can be used but the determination of density is required. In addition, while LiDAR has been used, this can provide false or inaccurate readings.

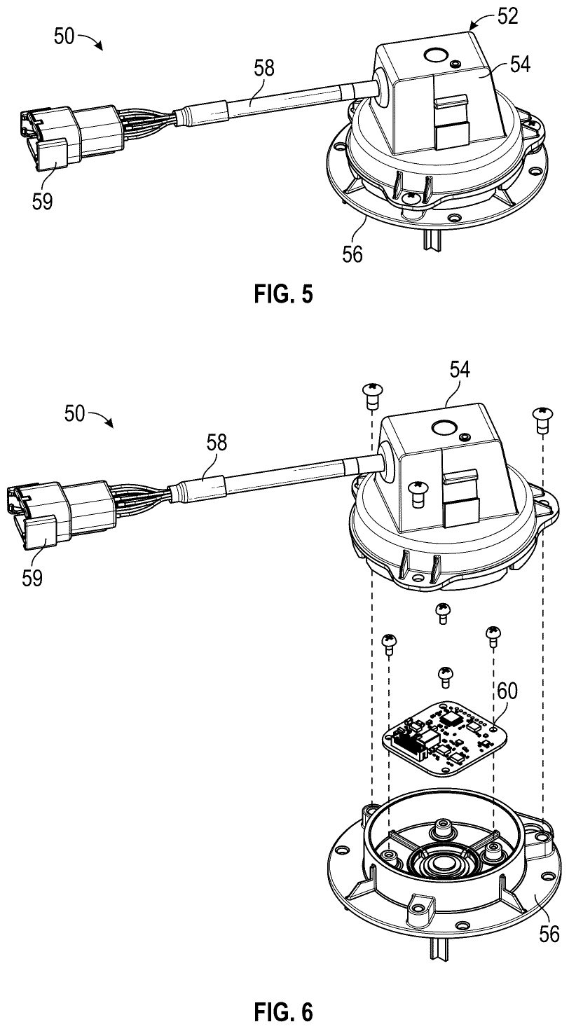

Therefore, as shown in FIGS. 5-6, aspects of the disclosure include a sensor system 50 that can provide better results for determining the volume of liquid fertilizer in the vessels, for when the implement is still or moving, and also irrespective of the angle or level of the implement or terrain.

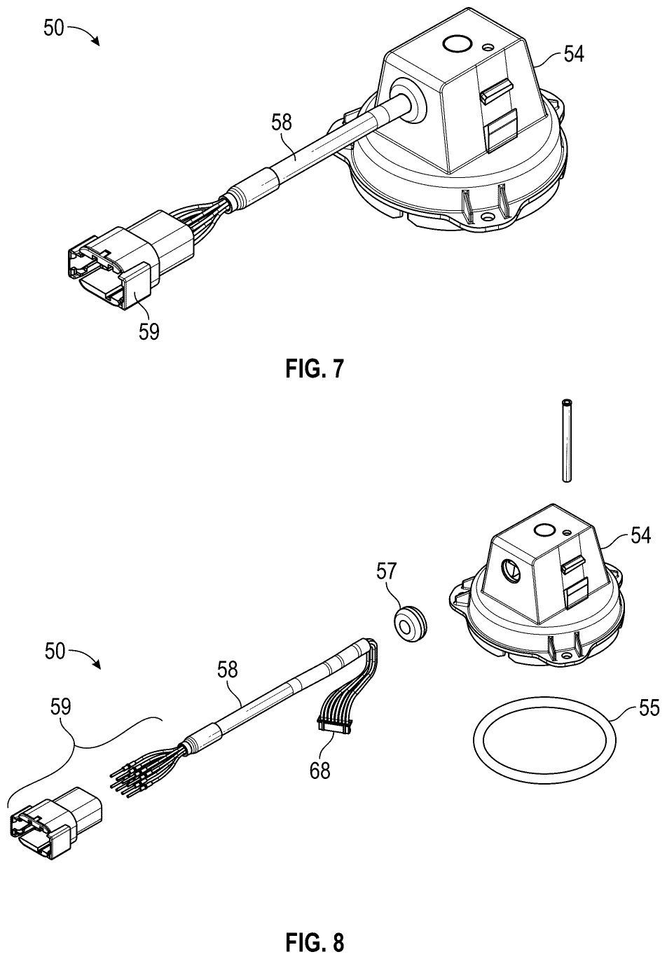

The sensory system 50 includes a housing 52. The housing 52 in the figures is shown to be two pieces—a cap portion 54 and a base portion 56. The cap portion 54 is shown in FIGS. 7 and 8 as well. It should be noted that both the cap and the base can take different configurations, shapes, or sizes than shown. The particular configuration shown in the figures is to allow the housing 52 to be positioned relative to a vessel, such as at an opening, to allow sensors to obtain information from inside the vessel (i.e., sensed data to determine volume of material therein).

Positioned between the portions of the housing 52 is a sensor assembly, which may take the form of a printed circuit board 60. The circuit board 60 includes various electrical components that can be used to obtain information, such as movement and/or volume information, and then can communicate the information to a different location, such as a user display 41. As will be understood, the communication of the data from the sensor to the display could be wired, wireless, or some combination. For example, the figures show a harness with wiring 58 connected to a pin connector 59. This wiring 58 is also connected at the opposite end to the circuit board 60 via a pin connector 68. The wiring 58 could be Ethernet, CAN, ISOBUS, or the like, which can communicate the information to another location. This could be directly to the display via wiring or could be sent to a node where it is emitted wirelessly to the display or another location, such as to or via cloud storage.

As shown in FIGS. 7 and 8, additional components of the housing and sensor system include grommets 57 and O-rings 55.

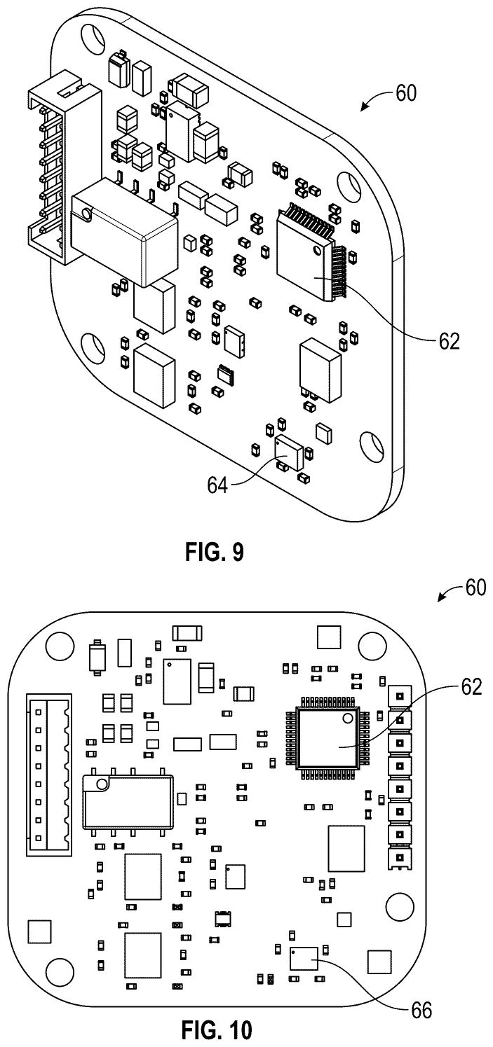

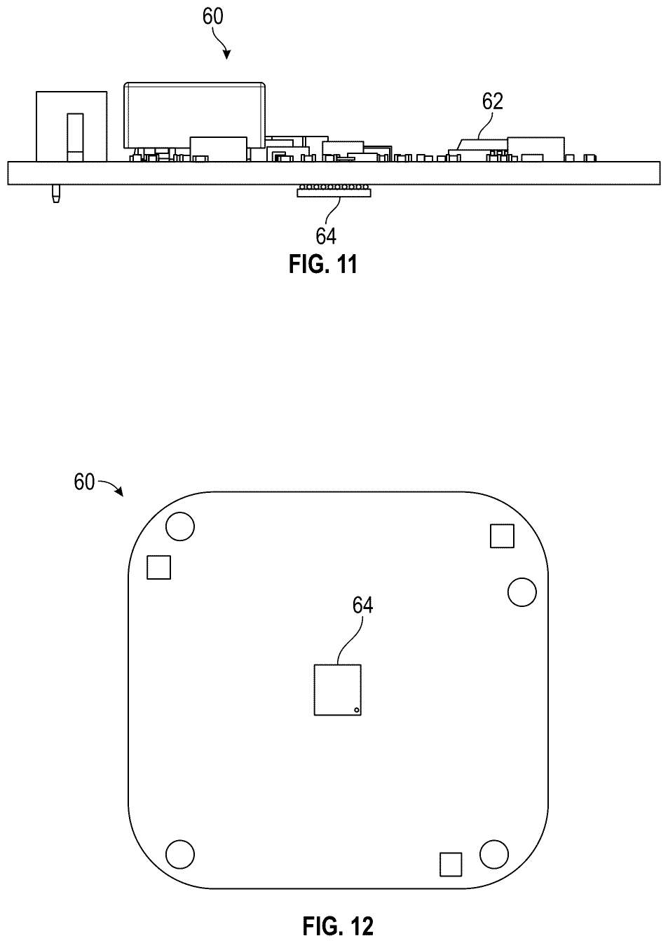

FIGS. 9-12 depict one example of the sensor 60 in the form of a printed circuit board 60. The circuit board 60 will include the electrical components that acquire, calculate, and/or communicate the information. For example, the sensor board 60 includes an intelligent control in the form of a controller unit 62, which may be a microcontroller unit. A microcontroller (MC, UC, or μC) or microcontroller unit (MCU) is a small computer on a single integrated circuit. A microcontroller contains one or more CPUs (processor cores) along with memory and programmable input/output peripherals.

Connected to the MCU 62 is a radar sensor 64, which is shown to be facing the opposite orientation as the rest of the components. The radar sensor 64 is shown to be a distance sensor using electromagnetics to determine time of flight. The radar sensor 64 shown in the figures is a 60 GHz sensor, but this should not be limiting on the disclosure. The radar sensor utilizes the electromagnetic signals to determine distance, which can then be used to determine one aspect of the volume of the liquid in the vessel.

As noted, the 60 GHz radar sensor could be replaced with other devices, such as “millimeter wave” sensors. Millimeter wave (mmWave), also known as millimeter band, is a range of electromagnetic frequencies between microwaves and infrared. Millimeter wave is a term that covers radar sensors that operate 30 GHz up to 300 GHz (wavelength of sub 10 mm—single digit millimeter). The advantage of the millimeter wavelength is these are extremely precise radars (being able to sense distance to within sub-10millimeter or 1 wavelength precision directly). Other radars achieve precision through time-dependent frequency modulation.

Additionally, the sensor board 60 includes an inertial movement unit/sensor 66 connected the MCU 62. An inertial measurement unit (IMU) is an electronic device that measures and reports a body's specific force, angular rate, and sometimes the orientation of the body, using a combination of accelerometers, gyroscopes, and sometimes magnetometers. According to at least some embodiments, the IMU 66 is a six-degrees-of-freedom sensor that includes an accelerometer and a gyroscope to provide additional information related to the liquid in the vessel.

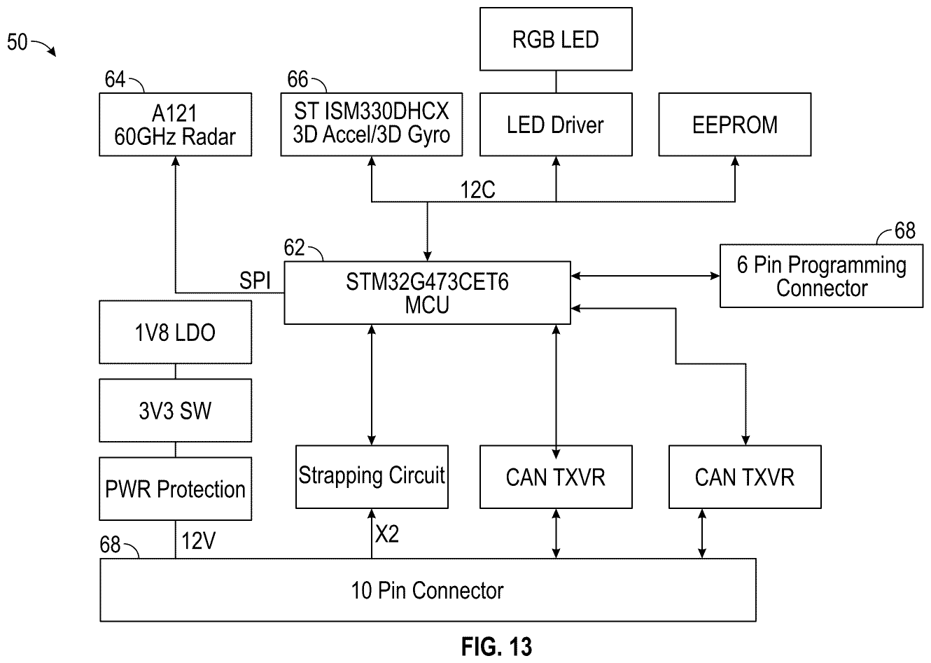

Additional components of the board 60 includes resistors, pin connectors, capacitors, diodes, LED lights, convertors, drivers, memory, and the like. A schematic of an example of at least some components and how they are connected is shown in FIG. 13.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The controller or other component in communication with the sensor will preferably include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using the compiler.

In one embodiment, the software application and the compiler are tangibly embodied in the computer-readable medium. When the instructions are read and executed by the non-transitory computer readable medium, the non-transitory computer readable medium performs the steps necessary to implement and/or use the present invention. A software application, operating instructions, and/or firmware (semi-permanent software programmed into read-only memory) may also be tangibly embodied in the memory and/or data communication devices, thereby making the software application a product or article of manufacture according to the present invention.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

The sensor system may include power systems. The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”) battery, a nickel-cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

As noted, the system may include a user interface. A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

As is also noted, the system can include numerous wired or wireless communication systems and/or networks. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

ISO 11783, known as Tractors and machinery for agriculture and forestry-Serial control and communications data network (commonly referred to as “ISO Bus” or “ISOBUS”) is a communication protocol for the agriculture industry based on the SAE J1939 protocol (which includes CANbus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group/collection of IEEE standards produced by the working group defining the physical layer and data link layer's media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

The Internet Protocol (“IP”) is the principal communications protocol in the Internet protocol suite for relaying datagrams across network boundaries. Its routing function enables internetworking, and essentially establishes the Internet. IP has the task of delivering packets from the source host to the destination host solely based on the IP addresses in the packet headers. For this purpose, IP defines packet structures that encapsulate the data to be delivered. It also defines addressing methods that are used to label the datagram with source and destination information.

The Transmission Control Protocol (“TCP”) is one of the main protocols of the Internet protocol suite. It originated in the initial network implementation in which it complemented the IP. Therefore, the entire suite is commonly referred to as TCP/IP. TCP provides reliable, ordered, and error-checked delivery of a stream of octets (bytes) between applications running on hosts communicating via an IP network. Major internet applications such as the World Wide Web, email, remote administration, and file transfer rely on TCP, which is part of the Transport Layer of the TCP/IP suite.

Transport Layer Security, and its predecessor Secure Sockets Layer (“SSL/TLS”), often runs on top of TCP. SSL/TLS are cryptographic protocols designed to provide communications security over a computer network. Several versions of the protocols find widespread use in applications such as web browsing, email, instant messaging, and voice over IP (“VoIP”). Websites can use TLS to secure all communications between their servers and web browsers.

In some embodiments, the sensor could include one or more communications ports such as Ethernet, serial advanced technology attachment (“SATA”), universal serial bus (“USB”), or integrated drive electronics (“IDE”), for transferring, receiving, or storing data.

Still further, the disclosure includes a method for determining the volume of a liquid in a moving vessel, such as the volume of liquid fertilizer in a tank of an implement while moving. According to some aspects of the disclosure, the steps of the method include:
Use of a phase coherent pulse radar which emits electromagnetic signals over time in which correlated phase is maintained between the signals, and sensing the reflected signals using a receive antenna, and processing those signals to derive the distance to the liquid that reflected it.
Use of the phase coherence of the electromagnetic signal to derive from the phase of the reflected signal over time the velocity of the liquid and any other matter that might generate signal reflections inside the tank for each signal return.
Use of the velocity information to discriminate between liquid that is not part of the volume to be measured (such as liquid stuck to the surface of the tank) and the moving liquid in the tank.
Use of an inertial sensor to calculate the angle of the tank and calculate an offset to the true level of the center of the tank, for the purpose of calculating the level and/or volume of the liquid.
Use of an inertial sensor (IMU) to detect when external movement forces are being applied to the tank, to determine when the liquid should be moving, and using that information to adjust the trust between the distance-only and distance-velocity detection.

Radar only measures distance to the surface of the liquid at a point immediately below the radar. If the liquid is moving or the tank is tilting due to changes in attitude, that presents a challenge in determining the liquid capacity. Therefore, the system and methods provided herein overcome such challenges and provide great advantages.

Our system employs using phase and/or frequency shift information to detect the velocity of liquid to simultaneously enhance detection accuracy and reliability and account for these effects when calculating liquid capacity.

Such a method can utilize the sensor system as has been disclosed herein to provide the needed information for the level (volume) of the liquid in the moving vessel of the agricultural implement.

Still further, while the disclosure has been directed towards the use of the sensor for determining the level or volume of a liquid material in a vessel, it should be appreciated that the sensor system could have additional applications.

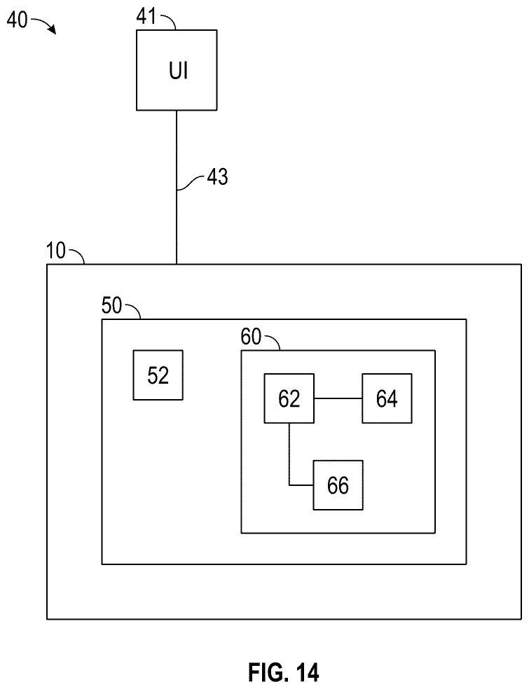

For example, FIG. 14 depicts a schematic where the sensor system 60 is positioned generically with an implement. This could be similar to the depiction of the sensor beneath the catwalk in FIG. 2. The sensor 64, MCU 62, and IMU 66 could be used to determine much information related to the implement. Such information could be related to the six-degrees-of-freedom, which can include heading, speed, orientation, pitch, yaw, etc. As shown, the information from the sensor 60 is communicated to a user interface 41. A line 43 is shown as the communication, and this could be wired or wireless communication, to provide the up to date information for the user, whether in a tractor or even fully remove from the location of operation of the implement.

The sensor would be positioned towards the ground to obtain up to date data from the electromagnetic signals emitted and returned. This information could be combined with the information from the IMU to determine one or more aspects related to the movement of the implement. Currently, multiple sensors spaced on the implement are used to attempt to determine such data, including the orientation. However, this has proved to be difficult. Therefore, having the sensor system as shown and described herein could improve upon and provide the needed information to obtain such different information results and then could communicate the same to a display in the tractor or even remote. This could be done with a single sensor system as well, such as described. In operation, the method would be similar to the method for determining volume in the vessel, wherein the radar sensor is using time of flight to acquire up to date information. This would be cross-referenced with information from the IMU to provide information that could be combined to result in useful information, including orientation, heading, etc.

Still additional information could be obtained and utilized by the disclosed features and should be considered to be a part of the disclosure. It should be appreciated the figures and associated description include numerous features, components, and elements of the present disclosure. While there has been some description of some embodiments, it should be appreciated that numerous additional embodiments and/or aspects thereof are supported by the figures and description, even if not explicitly stated. However, these additional embodiments and/or aspects thereof are to be considered a part of the disclosure.

1. A system for measuring and monitoring liquid volume in a moving vessel, comprising:
a user interface; and
a sensor system operatively connected to the moving vessel and operatively connected to the user interface, the sensor system comprising:
a sensor housing; and
a sensor circuit board positioned within the sensor housing and comprising a radar sensor comprising a radar sensor and an inertial movement sensor both connected to a control unit;
wherein the sensor system communicates volume of a liquid in the moving vessel to the user interface.

2. The system of claim 1, wherein the sensor housing comprises a cap and a base, wherein the sensor circuit board is positioned between the cap and base.

3. The system of claim 1, further comprising electrical wiring through a portion of the sensor housing to connect to the sensor circuit board.

4. The system of claim 3, wherein the electrical wiring connects the sensor system to the user interface.

5. The system of claim 4, wherein the electrical wiring comprises Ethernet.

6. The system of claim 1, wherein the sensor system is connected to the user interface wirelessly.

7. The system of claim 1, wherein the inertial movement sensor comprises a six degree-of-freedom sensor.

8. The system of claim 7, wherein the six degree-of-freedom sensor comprises a 3D accelerometer and a 3D gyroscope.

9. The system of claim 1, wherein the radar sensor comprises a 60 GHz radar sensor.

10. The system of claim 1, wherein the sensor circuit board comprises one or more pin connectors.

11. A sensor system for use with an agricultural implement, comprising:
a sensor housing;
an electronic sensor positioned within the sensor housing, the electronic sensor comprising:
a control unit;
a radar sensor coupled to the control unit; and
an inertial movement sensor coupled to the control unit;
wherein the inertial movement sensor comprises six degrees-of-freedom sensing.

12. The sensor system of claim 11, wherein the radar sensor comprises a 60 GHz radar sensor.

13. The sensor system of claim 11, wherein the sensor housing comprises a cap and a base, wherein the sensor circuit board is positioned between the cap and base.

14. The sensor system of claim 11, wherein the inertial movement sensor comprises a 3D accelerometer and a 3D gyroscope.

15. The sensor system of claim 11, wherein the agricultural implement comprises a planting implement.

16. The sensor system of claim 11, further comprising a user interface in communication with the electronic sensor and configured to display information obtained by the sensor.

17. A method of sensing a liquid volume of a liquid in a moving vessel, comprising:
sensing, via a radar sensor, reflected signals from the liquid to determine a distance to the liquid in the vessel;
determining, via the radar sensor, a phase coherence of an inside of the vessel;
measuring velocity information of the liquid moving in the vessel;
determining, via an inertial movement sensor, an angle of the moving vessel to provide an offset to a known level of the vessel;
detecting, via the inertial movement sensor, an external movement force being applied to the vessel to determine when the liquid should be moving; and
determining, based on the detection, a trust value between the distance of the liquid determined in the vessel and velocity information of the liquid.

18. The method of claim 17, wherein the step of sensing comprising use of a phase coherent pulse radar that emits electromagnetic signals over time in which correlated phase is maintained between the electromagnetic signals.

19. The method of claim 17, further comprising comparing the measured velocity information with other material in the vessel that generates a signal reflection.

20. The method of claim 19, further comprising using the velocity information to discriminate between a liquid that is not part of the volume to be measured and the moving liquid in the vessel.
